(19) United States
(12) Patent Application Publication
(10) Pub. No.: US 2003/0230118 A1
(43) Pub. Date: Dec. 18, 2003

(54) Methods and preforms for drawing microstructured optical fibers

(76) Inventors: Steven B. Dawes, Corning, NY (US); Michael T. Gallagher, Corning, NY (US); Daniel W. Hawtof, Corning, NY (US); Natesan Venkataraman, Corning, NY (US)

Correspondence Address: CORNING INCORPORATED, SP-TI-3-1, CORNING, NY, 14831

(21) Appl. No.: 10/171,335

(22) Filed: Jun. 12, 2002

(51) Int. Cl. C03B 37/07; C03B 37/075

(52) U.S. Cl. 65/379; 65/409; 65/393

(57) ABSTRACT

The present invention provides a method for drawing microstructured fibers. A preform having a first set of holes and a second set of holes is provided, and the first set of holes is coupled to a first pressure system, while the second set of holes remains substantially uncoupled to the first pressure system. The pressures of the sets of holes may be independently set or controlled to yield a desired hole geometry in the drawn microstructured optical fiber. The present invention also provides preforms suitable for use with the methods of the invention.

### BACKGROUND OF THE INVENTION

1. Field of the Invention

The present invention relates generally to optical fibers, and more specifically to microstructured optical fibers and methods and preforms for drawing microstructured optical fibers.

2. Technical Background

Optical fibers formed completely from glass materials have been in commercial use for more than two decades. Although such optical fibers have represented a leap forward in the field of telecommunications, work on alternative optical fiber designs continues. One promising type of alternative optical fiber is a microstructured optical fiber, which includes holes or voids running longitudinally along the fiber axis. The holes generally contain air or an inert gas, but may also contain other materials.

Microstructured optical fibers may be designed to have a wide variety of properties, and may be used in a wide variety of applications. For example, microstructured optical fibers having a solid glass core and a plurality of holes disposed in the cladding region around the core have been constructed. The position and sizes of the holes may be designed to yield microstructured optical fibers with dispersions ranging anywhere from large negative values to large positive values. Such fibers may be useful, for example, in dispersion compensation. Solid-core microstructured optical fibers may also be designed to be single mode over a wide range of wavelengths. Most solid-core microstructured optical fibers guide light by a total internal reflection mechanism; the low index of the holes acts to lower the index of the cladding region in which they are disposed.

One especially interesting type of microstructured optical fiber is the photonic band gap fiber. Photonic band gap fibers guide light by a mechanism that is fundamentally different from the total internal reflection mechanism. Photonic band gap fibers have a photonic crystal structure formed in the cladding of the fiber. The photonic crystal structure is a periodic array of holes having a spacing on the order of the wavelength of light. The core of the fiber is formed by a defect in the photonic crystal structure cladding. For example, the defect may be a hole of a substantially different size and/or shape than the holes of the photonic crystal structure. The photonic crystal structure has a range of frequencies, known as the band gap, for which light is forbidden to propagate in the photonic crystal structure. Light introduced into the core of the fiber having a frequency within the band gap will not propagate in the photonic crystal cladding, and will therefore be confined to the core. A photonic band gap fiber may have a core that is formed from a hole larger than those of the photonic crystal structure; in such a hollow-core fiber, the light may be guided in a gaseous medium, lowering losses due to absorption and Rayleigh scattering of glass materials. As the light is guided in a gaseous medium, hollow-core fiber may have extremely low non-linearity.

Microstructured optical fibers are fabricated using methods roughly analogous to the manufacture of all-glass optical fiber. A preform having the desired arrangement of holes is formed, then drawn into fiber using heat and tension. In the drawing process, the size, shape, and arrangement of the holes may be significantly distorted due to the softness of the material and surface tension inside the holes. Such distortions may be especially damaging in hollow-core photonic band gap fiber, as the band gap may be quite sensitive to variations in characteristic dimensions of the photonic crystal structure such as hole size, pitch and symmetry.

### SUMMARY OF THE INVENTION

One aspect of the present invention relates to a method for making a microstructured optical fiber, the method including the steps of providing a preform having a proximal end and a distal end, a first set of holes and a second set of holes, both holes being formed longitudinally through the preform between the proximal end and the distal end; providing at least one pressure system; coupling the first set of holes to a first pressure system of the at least one pressure system at the proximal end of the preform; and drawing the preform from the distal end to form the microstructured optical fiber, wherein during the drawing step, the second set of holes is substantially uncoupled from the first pressure system.

In one embodiment of the invention, the step of providing the preform includes the steps of forming a preform having a proximal end and a distal end, a first set of holes and a second set of holes, each set of holes being formed longitudinally along the preform between the proximal end and the distal end, the preform being formed from a material; sealing the holes at the proximal end of the preform; heating the proximal end of the preform to a temperature near the softening point of the material of the preform; applying pressure to the holes at the distal end of the preform, thereby expanding the holes of the preform at its proximal end; and cleaving the proximal end of the preform, thereby exposing the expanded holes.

In another embodiment of the invention, the step of coupling the first set of holes to a first pressure system includes the steps of providing a hollow tube having a proximal end and a distal end for each hole of the first set of holes; inserting the proximal end of one hollow tube into each hole of the first set of holes at the proximal end of the preform; affixing the proximal end of each hollow tube to the preform using a holding material, thereby coupling the hollow tube to the hole; and coupling the distal end of each hollow tube to the first pressure system.

In another embodiment of the present invention, the preform includes a first region including the first set of holes and a second region surrounding the first region, and wherein at the proximal end of the preform, the first region of the preform protrudes from the second region of the preform.

Another aspect of the present invention relates to a method for making a microstructured optical fiber including the steps of providing a preform having a proximal end and a distal end, and a first set of holes and a second set of holes, both sets of holes being formed longitudinally through the preform between the proximal end and the distal end; forming a porous material in each hole of the first set of holes at the proximal end of the preform; coupling the first set of holes and the second set of holes to a first pressure system; and drawing the preform from the distal end to form the microstructured optical fiber, wherein the holding material has a porosity sufficient to partially inhibit flow between the first set of holes and the second set of holes.

Other aspects of the present invention relate to the preforms used in the mehtods described herein, and to the microstructured optical fibers fabricated using the methods described herein. For example, one aspect of the present invention relates to a microstructured optical fiber preform comprising a first set of holes and a second set of holes, the holes being formed longitudinally through the preform between a proximal end and a distal end; wherein the first set of holes is coupled to a first pressure system at the proximal end of the preform, the first pressure system being substantially uncoupled from the second set of holes.

The methods and preforms of the present invention result in a number of advantages over conventional methods and preforms. The present invention allows for microstructured optical fiber with a wide variety of structures to be drawn with tight control of feature geometry (e.g. pitch, hole size) during the draw. The present invention enables individual pressure control of different sets of holes of a microstructured optical fiber preform. Hollow-core photonic band gap fibers having relatively large core holes may be made without unwanted core hole distortion. The techniques of the present invention may allow for microstructured optical fiber having fully collapsed interstitial holes to be drawn directly from a stacked bundle of capillaries, without the need for an intermediate drawing step to collapse interstitial holes. The microstructured optical fibers of the present invention may be made in long lengths having uniform cross-section. The present invention allows for a high degree of process repeatability in the manufacture of microstructured optical fibers. Additional features and advantages of the invention will be set forth in the detailed description which follows, and in part will be readily apparent to those skilled in the art from the description or recognized by practicing the invention as described in the written description and claims hereof, as well as in the appended drawings.

It is to be understood that both the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification. The drawings are not necessarily to scale. The drawings illustrate one or more embodiment(s) of the invention, and together with the description serve to explain the principles and operation of the invention.

### BRIEF DESCRIPTION OF THE DRAWINGS

FIG. 1 is a schematic diagram of an optical fiber preform for the production of an effective index-guided microstructured optical fiber according to one embodiment of the present invention;

FIG. 2 is a schematic diagram of an apparatus for use in the production of an effective index-guided microstructured optical fiber according to one embodiment of the present invention;

FIG. 3 is a schematic diagram of an optical fiber preform for the production of a photonic band gap fiber;

FIG. 4 is a schematic diagram of a cross-sectional view of an optical fiber drawn from the preform of FIG. 3 under a single pressure;

FIG. 5 is a schematic diagram of an optical fiber preform for the production of a photonic band gap fiber according to an embodiment of the present invention;

FIG. 6 is a schematic diagram of an apparatus used to draw a photonic band gap fiber according to an embodiment of the present invention.

FIG. 7 is a schematic diagram of a method of making an optical fiber preform with expanded holes at its proximal end;

FIG. 8 is a schematic diagram of an apparatus used to draw a preform having expanded holes at its proximal end into an optical fiber;

FIG. 9 is a schematic diagram of a method of coupling the holes of an optical fiber preform to different pressure control systems according to an embodiment of the present invention;

FIG. 10 is a schematic diagram of a method of coupling the holes of an optical fiber preform to different pressure control systems according to an embodiment of the present invention;

FIG. 11 is a schematic diagram of a method of coupling the holes of an optical fiber preform to different pressure control systems according to an embodiment of the present invention;

FIG. 12 is a schematic diagram of a method of coupling the holes of an optical fiber preform to different pressure control systems according to an embodiment of the present invention;

FIG. 13 is a schematic diagram of an example of a stack-and-draw method for making a microstructured optical fiber; and

FIG. 14 is a schematic diagram of an example of an etching process used to enlarge the core defect in a photonic band gap fiber preform.

### DETAILED DESCRIPTION OF THE PREFERRED EMBODIMENTS

In one aspect of the present invention, a method for forming microstructured optical fiber is provided. In this method, a preform having a first set of holes and a second set of holes is provided. The first set of holes is coupled to a first pressure system. The second set of holes may optionally be coupled to a second pressure system. As used herein, the proximal end of a preform is the end at which holes of the preform are coupled to a pressure system. The preform is drawn to form the microstructured optical fiber. As used herein, the distal end of the preform is the end of the preform from which fiber is drawn (generally opposite the proximal end). The During the drawing step, the second set of holes is substantially uncoupled from the first pressure system. As will be described more fully below, the first pressure control system may be controlled in order to control the sizes of the first sets of holes in the drawn optical fiber.

As used herein, a pressure system is a volume of space external to the preform. The atmosphere of the furnace in which the microstructured optical fiber is being drawn is considered herein to be a pressure system. A U-shaped glass tube with a water column may be used by the skilled artisan as a pressure system having a substantially fixed pressure. A pressure system may be a pressure control system, in which the pressure is controllable by the skilled artisan. Pressure control systems may be, for example, a positive pressure system such as a source of helium or argon gas pressure; or a negative pressure system such as a vacuum system. A more complicated pressure control system may include a pressure sensor, a vacuum system, a gas pressure source, and a controller that monitors the pressure and uses vacuum and/or gas pressure to maintain the pressure of the system at a desired value. Any holes that are not coupled to a pressure system at the proximal end of the preform are sealed closed or otherwise substantially inhibited from fluid communication with the exterior of the preform through its proximal end. Pressure systems are considered to be substantially uncoupled if fluid communication between the pressure systems is substantially inhibited. While a preform is being drawn into fiber, the first set of holes and the second set of holes at the drawn end of the fiber may be open to the atmosphere. However, the small size (microns in diameter) of these holes combined with the length of the fiber will substantially inhibit fluid communication through them. The pressure systems are therefore considered to be substantially uncoupled at the distal end of the preform during the draw.

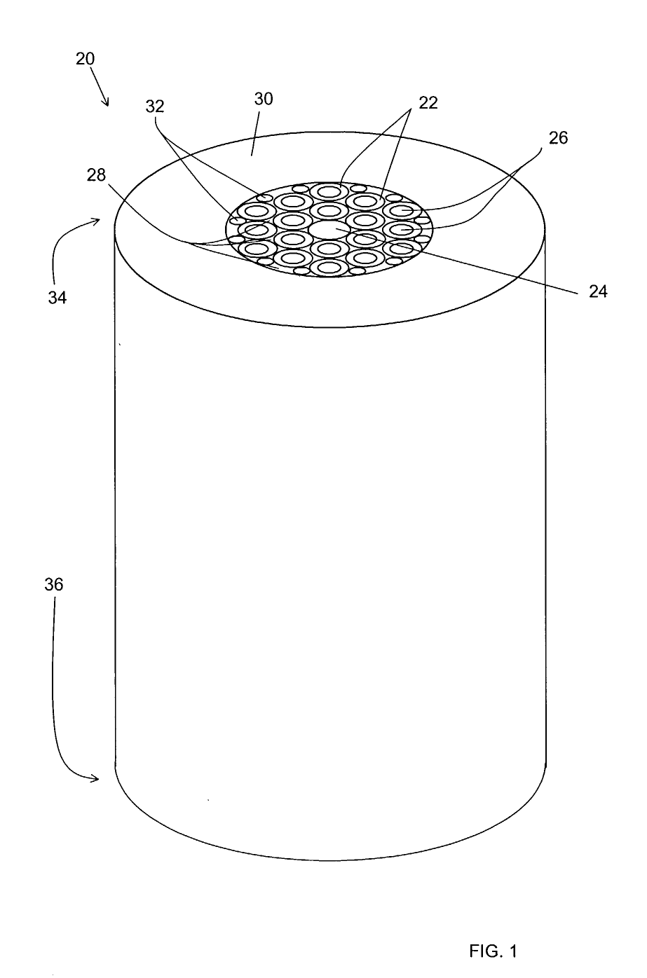

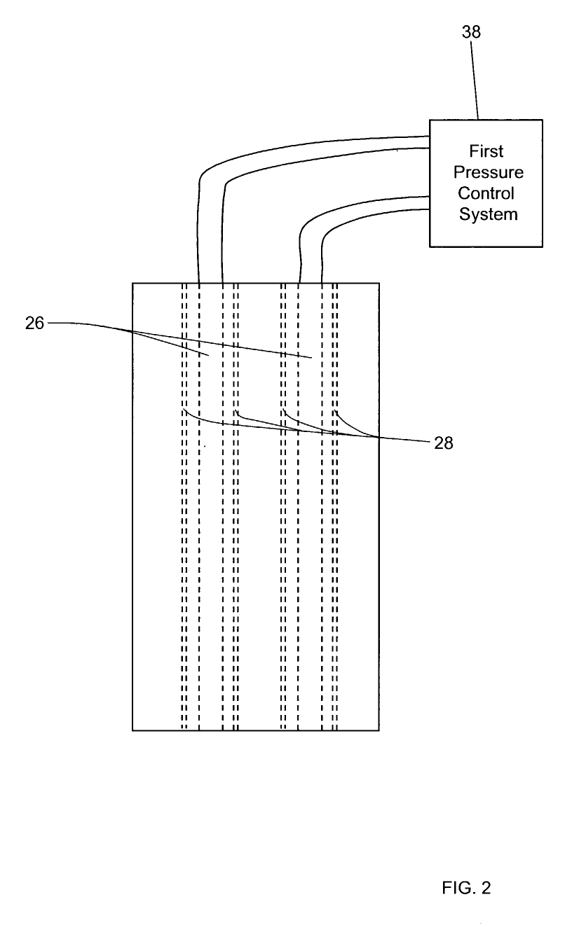

An embodiment of an optical fiber preform for the production of an effective index-guided microstructured optical fiber is shown in FIG. 1. The preform 20 is constructed from a bundle of round capillaries 22 surrounding a solid core rod 24. The first set of holes 26 is formed by the insides of the round capillaries, and forms an effective index cladding region for the solid core 24. The second set of holes 28 is formed by the interstitial spaces between the exterior surfaces of the round capillaries. The bundle of capillaries is positioned inside a large sleeve tube 30, using spacer rods 32. As shown in side view in FIG. 2, the first set of holes 26 is coupled to a first pressure control system 38 at the proximal end 34 of the preform. The second set of holes is coupled to the atmosphere of the furnace, which acts as the second pressure system in this embodiment. The preform is drawn from its distal end to form an optical fiber. During the drawing of the fiber, the first pressure control system maintains a positive pressure on the holes of the first set of holes to keep them open, while the holes of the second set of holes remain at the furnace pressure, and close due to surface tension. This technique may allow for a microstructured optical fiber to be drawn directly from a bundle of tubes, without resorting to an intermediate drawing step to reduce the size of the preform and collapse interstitial holes.

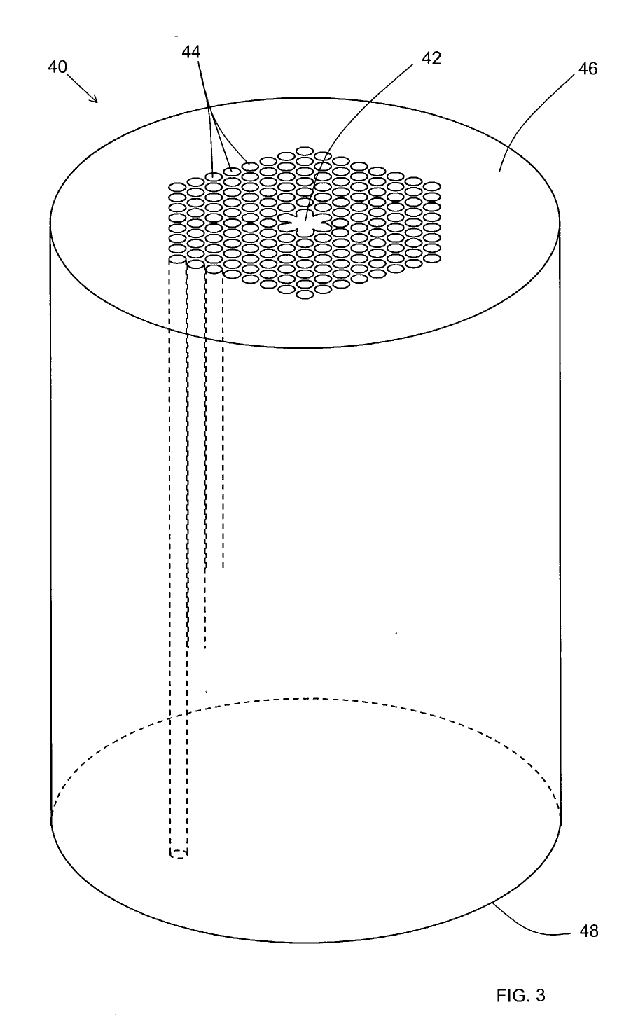

In another aspect of the present invention, the first set of holes is coupled to a first pressure system, and the second set of holes is coupled to a second pressure system. Both pressure systems may be pressure control systems. An embodiment of an optical fiber preform for the production of a photonic band gap fiber according to this aspect of the invention is shown in FIG. 3. The preform 40 has a first set of holes 42, a second set of holes 44, a proximal end 46, and a distal end 48. The holes are formed longitudinally through the preform from the proximal end to the distal end. In the embodiment of FIG. 3, the first set of holes includes only one large hole; this core hole will form the core of a photonic band gap fiber. The second set of holes is formed in a periodic array, and will form the photonic crystal cladding of the photonic band gap fiber.

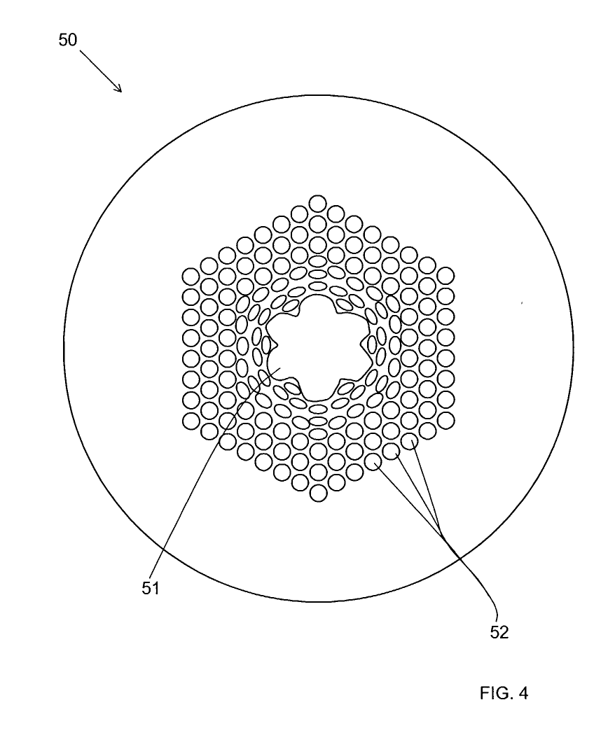

If the preform of FIG. 3 is drawn into fiber from the distal end with a single pressure applied to both sets of holes at the proximal end, substantial distortion of the microstructure often results, as shown in the cross-sectional view of FIG. 4. In particular, in the drawn fiber 50, the core hole 51 is distorted to be much larger in size relative to the holes 52 of the photonic crystal cladding. Without being bound to any particular theory, the inventors surmise that during the draw, the force due to surface tension in the large core hole is less than the force due to surface tension in the small photonic crystal holes, and so a smaller pressure is necessary to maintain the size of the core hole than of the photonic crystal hole. At an equal pressure, the core hole will tend to expand relative to the photonic crystal holes.

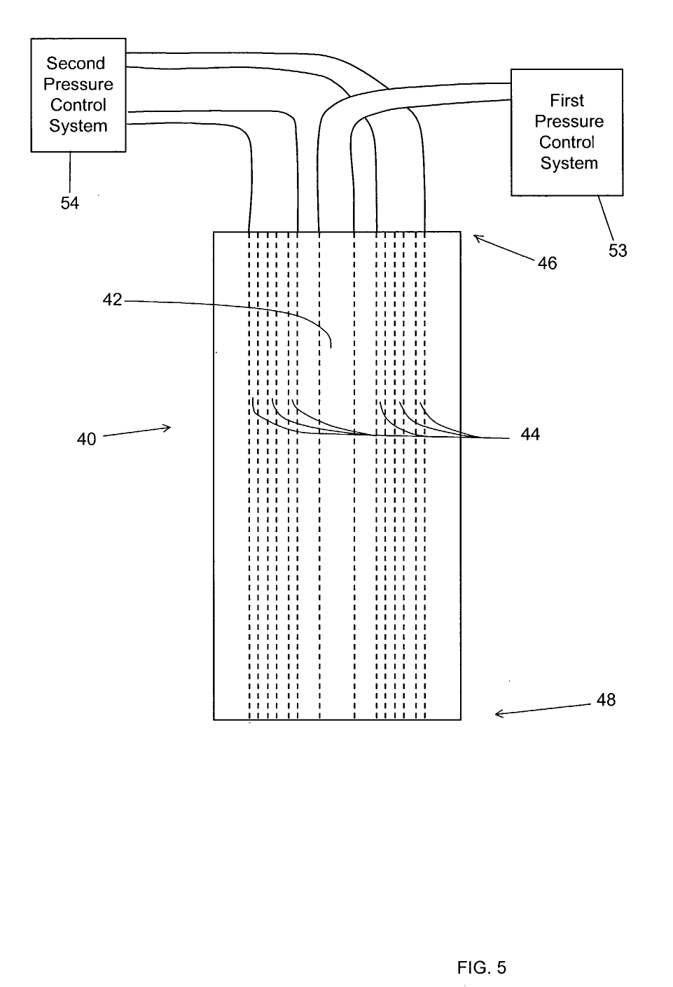

It is therefore desirable to have independent control of the pressures of the first set of holes and of the second set of holes. FIG. 5 is a schematic depiction of an optical fiber preform that may be used to draw a microstructured optical fiber according to an embodiment of the present invention. A preform 40 having a first set of holes 42 and a second set of holes 44 is provided. At the proximal end 46 of the preform, the first set of holes is coupled to a first pressure control system 53, and the second set of holes is coupled to a second pressure control system 54. The preform is drawn from its distal end 48 to form an optical fiber. During the drawing of the fiber, the first pressure control system may be set to a different pressure than the second pressure control system. For example, the skilled artisan may set the pressure of the first pressure control system to be less than the pressure of the second pressure control system in order to maintain the relative sizes of the two sets of holes, thereby avoiding the distortion described above in connection with FIG. 4.

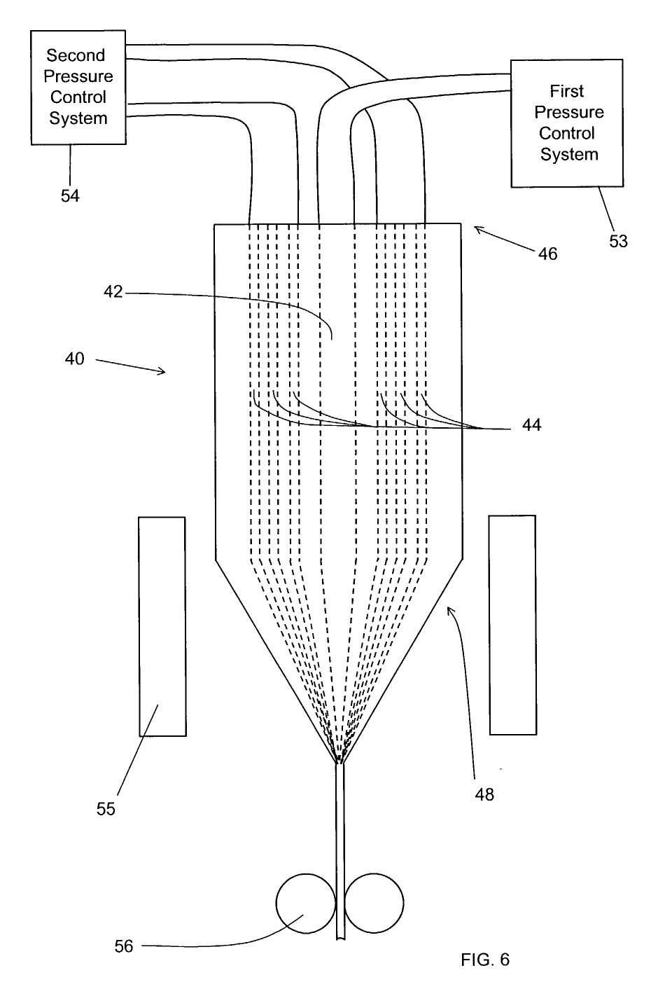

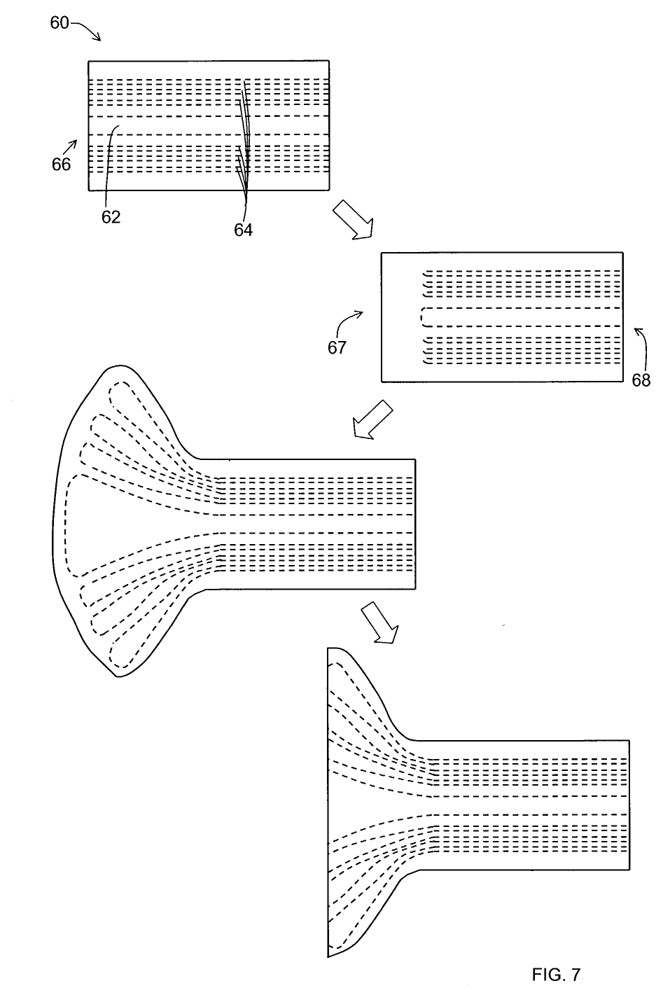

FIG. 6 is a schematic of a system that may be used to draw a microstructured optical fiber in accordance with the present invention. A preform 40 having a first set of holes 42 and a second set of holes 44 is provided. At the proximal end 46 of the preform, the first set of holes is coupled to a first pressure control system 53. In the embodiment of FIG. 6, the second set of holes is coupled to a second pressure control system 54. At the distal end 48 of the preform, the apparatus includes a conventional heat source 55 and a conventional fiber drawing mechanism 56, as will be appreciated by the skilled artisan.

In the process of drawing a microstructured optical fiber, the skilled artisan may independently control the pressures of each of the pressure control systems. For example, when the second set of holes is maintained at furnace pressure, a first pressure control system may be set to a positive pressure in order to keep the first set of holes open. In cases where two independent pressure control systems are used, the first pressure control system may be set to a substantially different pressure than the second pressure control system. By controlling the pressures of the pressure control systems, the skilled artisan can control the pressures inside the holes at the distal end of the preform while drawing the fiber. The skilled artisan can control the pressures inside the holes in order to expand, maintain, or reduce the relative diameters of the holes during the draw. For example, in cases where each of the first set of holes have a larger cross-sectional area than each of the holes of the second set of holes, as is the case in the preform of FIG. 3, it may be desirable to have the first pressure control system set to a lower pressure than the second pressure control system, and to have the pressure inside the first set of holes lower than the pressure inside the second set of holes. In other cases, it may be desirable to have the first pressure system set to a higher pressure than the second pressure system. For example, when the second set of holes is formed by interstitial spaces between capillaries, the second pressure control system may place a slight vacuum on the second set of holes to ensure their closure during the draw.

Feedback control may be used to control the pressure of at least one of the pressure control systems. For example, the sizes of the holes may be monitored, and the size information used as part of a feedback system to control the pressure. Alternatively, a pressure monitor may be coupled to one of the sets of holes, and the pressure information used as part of a feedback system to control the pressure.

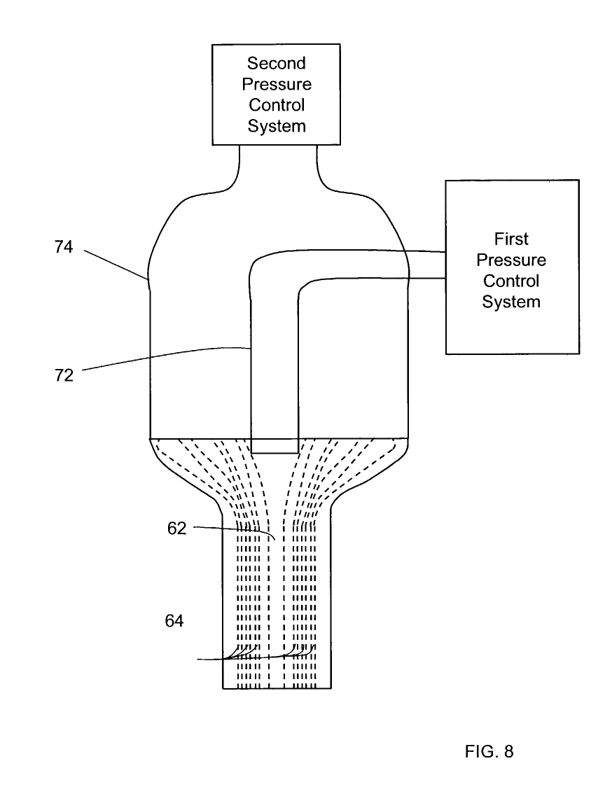

As the skilled artisan will appreciate, the holes of a preform used to make microstructured optical fiber can be quite small (e.g. less than a few hundred microns in diameter); coupling different holes of a microstructured optical fiber preform to different pressure systems is not a trivial task. The present disclosure describes several inventive methods and preform structures for achieving this end. For example, one aspect of the present invention provides an microstructured optical fiber preform having expanded holes at its proximal end. An example of a method for fabricating a microstructured optical fiber preform is shown in FIG. 7. A preform 60 is provided in which the first set of holes is a core hole 62, and the second set of holes 64 forms a photonic crystal cladding structure. The holes of the preform of this example have diameters of less than a few hundred microns, making them quite difficult to access for individual coupling to pressure systems. The proximal end 66 of the preform is sealed by heating the end to collapse the holes. The sealed proximal end 67 of the preform is heated to near the softening point of the material of the preform, for example, with a H₂/O₂ torch. A gas pressure is applied to the holes of the preform from the distal end 68. The gas pressure is controlled to expand the holes of the preform at the softened proximal end. The holes may be expanded roughly equally, by as much as 10 to 100 times their initial diameters. The expanded proximal end of the preform is allowed to cool, and is opened, for example by cleaving, breaking, grinding, laser machining or sawing, to expose the now enlarged holes. The desired holes may then be individually coupled to pressure systems by fitting small glass tubes into their expanded proximal ends. The outside circumference of the preform can be fitted with a single tube to access any holes not individually fitted with tubes. The tubes may be sealed to the preform by re-heating the end with minimal pressure applied to the holes, thereby sealing the tubes while preventing collapse of the holes. Alternatively, an epoxy, a frit material, or a glass sealing material may be used to fit the small glass tubes into the expanded holes of the preform. For example, as shown in FIG. 8, the first set of holes (core hole 62) may be coupled to a first pressure system by a tube 72 sealed into the core hole, while the second set of holes 64 may be coupled to a second pressure system by the larger single tube 74. In the embodiment of FIG. 8, the inner smaller tube 72 is formed to penetrate through the outer larger tube 74, allowing the tubes 72 and 74 to be coupled independently.

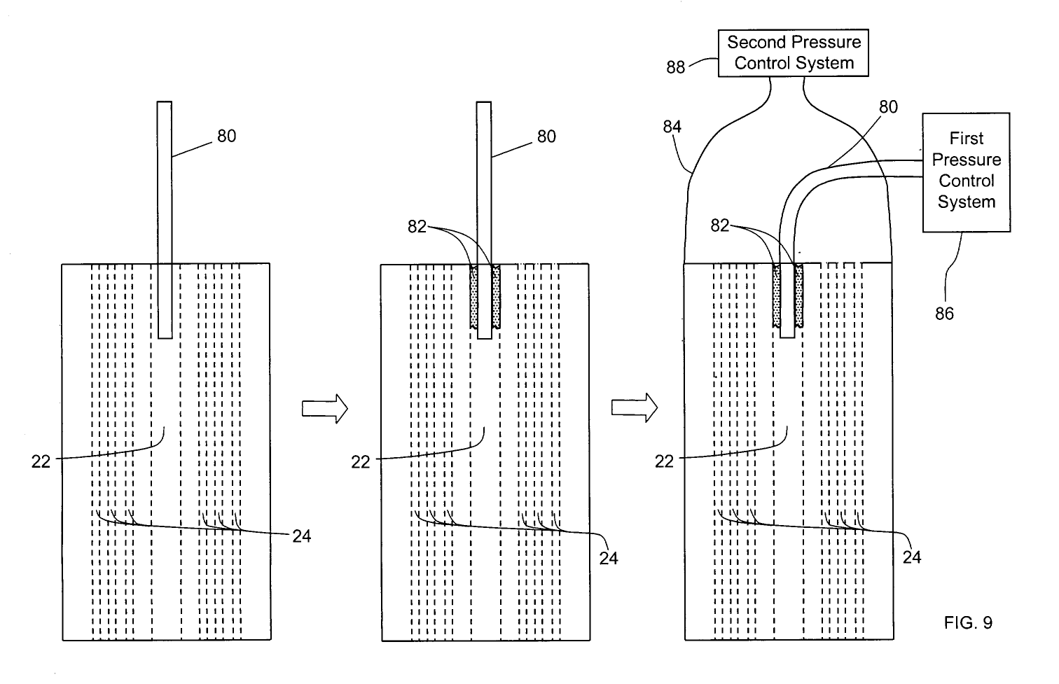

Another aspect of the present invention provides an optical fiber preform having tubes inserted into the holes of the first set of holes. The tubes are held into place with a holding material. An example of a method of preparing such a preform and coupling it to pressure systems is shown in FIG. 9. A preform as described in connection with FIG. 3 is provided. A hollow tube 80 is placed into the core hole 22 at the proximal end of the preform, and held in place while a holding material 82 is formed in the core hole around the tube, holding the tube in place. A larger tube 84 is affixed around the outside of the preform, and the hollow tubes 80 and 84 are coupled to first and second pressure control systems 86 and 88 as described with reference to FIG. 5, allowing for independent control of the pressure of the first set of holes (the core hole 22) and the second set of holes 24.

The holding material may be, for example, a sol-gel derived material. A viscous sol may be injected around the hollow tube 80, then allowed to gel. The gel is then heated in order to remove solvent and additives and to further densify the gel. The sol-gel derived material is preferably one that does not exhibit substantial shrinkage during processing, so that its porosity is not increased by the formation of cracks. For example, a suitable sol-gel derived material is described in U.S. Pat. No. 6,209,357. In this method, particulate silica (preferably about 50-100 m²/g surface area) is suspended in a highly basic (pH˜11.5) dispersant at high concentrations (˜30-70 wt %) and stabilized with tetramethylammonium hydroxide (˜1.5 wt %) to form a sol. In these highly basic conditions, the silica particles have a negative surface charge, and therefore repulse one another. Under these conditions, there is significant dissolution of silica from the surfaces of the particles. Addition of sodium chloride (˜1.5 wt %) and tetramethylammonium chloride (˜1.25 wt %) allows the sol to gel by screening the surface charge of the particulate silica. During aging of the gel, dissolved silica precipitates primarily onto the junctions of the densely packed particles via Ostwald ripening. The use of surface charge screening to induce gelation yields a gel that does not shrink significantly during drying, allowing the holding material to adhere to the sides of the hole. The skilled artisan may select other sol-gel processes to form the holding material of the present invention.

The holding material obtained using the sol-gel process may have some residual porosity, but will substantially inhibit gas flow between the first pressure system and the second set of holes. As such, fluid communication between the first pressure system and the second set of holes is substantially inhibited, and the second set of holes is substantially uncoupled from the first pressure system. The pressures of the two pressure systems may be set to take any residual porosity into account, and to yield the desired pressures in the holes during the draw. The holding material may also be a substantially non-porous material that seals the hollow tube 80 into core hole 22, allowing essentially no gas flow between the first set of holes and the second set of holes. For example, a low-melting glass, a high temperature cement, or an organic/inorganic hybrid sol-gel derived material may be used. It is desirable for the holding material to be able to withstand the temperatures experienced by the proximal end of the preform in the draw tower.

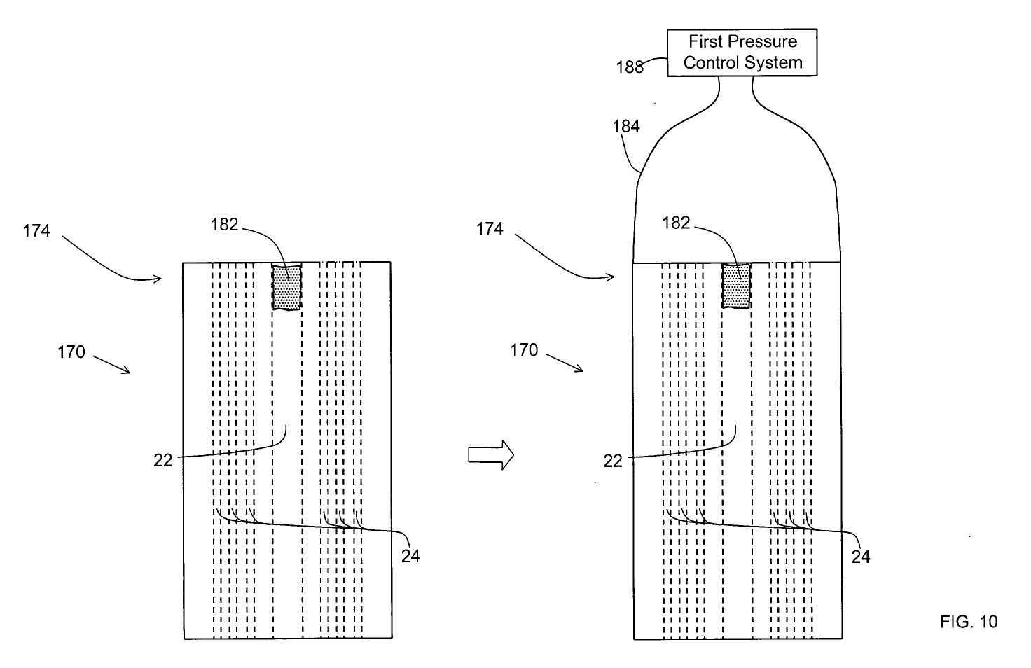

In another aspect of the present invention, a porous material is used to create a pressure drop between a first set of holes and a second set of holes. An example of a method of fabricating a microstructured optical fiber according to this aspect of the invention is shown in FIG. 10. A microstructured optical fiber preform 170 having a first set of holes (core hole 22) and a second set of holes (holes 24 of a photonic crystal structure) is provided. At the proximal end 174 of the preform, a plug of porous material 182 is formed in core hole 22. The plug of material has a porosity and a thickness sufficient to partially inhibit the flow through the plug. This material can be, for example, a sol-gel derived material as described above with reference to FIG. 9. The pressure drop across the plug, can be controlled by the using methods familiar to the skilled artisan. For example, the porosity of the plug can be controlled by selecting a desired particle size distribution and sol-gel process parameters. The thickness of the plug can be controlled by the volume of the sol that is inserted into the hole. After formation of porous plug 182, both sets of holes are coupled to a first pressure control system 188 via tube 184. In the embodiment of FIG. 10, the second set of holes is coupled directly to the first pressure control system 188, and will be at the same pressure as the pressure control system. The first set of holes is coupled to the first pressure control system 188 through the porous plug 182, and will be at a somewhat lower pressure during the draw than the pressure control system 188 due to the pressure drop across the porous plug. The skilled artisan may select the porosity and the thickness of the plug to create a pressure differential between the first set of holes and the second set of holes to, for example, prevent the core hole distortion described above in connection with FIG. 4. In another embodiment of the invention, the skilled artisan may used the porous plug described in connection with FIG. 10 as the holding material described in connection with FIG. 9.

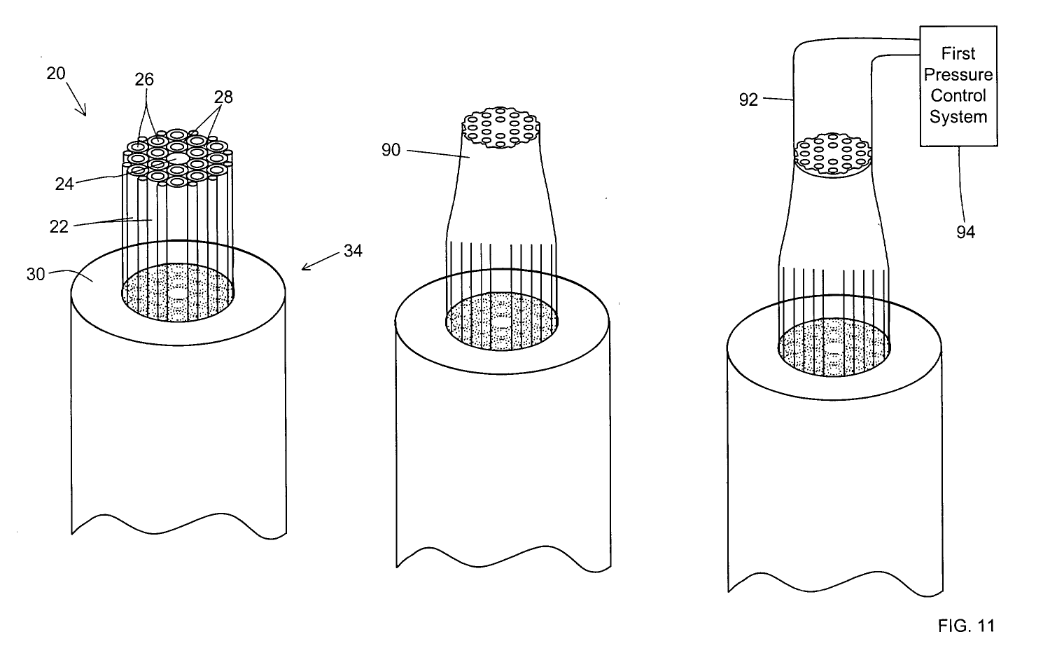

Another aspect of the present invention provides a preform having a first region including a first set of holes, and a second region surrounding the first region, wherein at the proximal end of the preform, the first region of the preform protrudes from the second region of the preform, thereby facilitating the coupling of the different sets of holes to different pressure systems. For example, FIG. 11 shows a method for coupling the holes of an effective index-guided optical fiber preform to different pressure systems. The preform 20 has a solid core 24, and a first set of holes 26 formed by the insides of round capillaries 22. The first set of holes forms an effective index cladding region for the solid core. The second set of holes 28 is formed by the interstitial spaces between the round capillaries. The capillaries are held in a sleeve 30. At their proximal ends, the capillaries 22 are heated and pulled to fuse the exterior surfaces of the capillaries. The fused portion 90 does not extend into the sleeve. At the proximal end 34 of the preform, the first region (formed by the fused capillaries) protrudes from the second region (formed by the sleeve), preferably by at least about 6 mm, more preferably by at least about 12 mm, and even more preferably by at least about 25 mm. The amount of protrusion is selected to be sufficient to enable facile coupling of one set of holes without disturbing another set of holes. A hollow tube 92 may be sealed to the exterior of the fused bunch of capillaries, thereby providing an avenue for common pressure control of the first set of holes with a first pressure control system 94. Since the interstitial holes are collapsed in the fused portion, they are not coupled through hollow tube 92 to the first pressure control system. Since the fused portion of the capillaries does not extend into the sleeve, the interstitial spaces making up the second set of holes is coupled to the atmosphere, which acts as a second pressure system. During the draw, the pressure of the first pressure control system may be set to maintain the diameters of the holes of the first set of holes, while the holes of the second set of holes (the interstitial spaces) are allowed to collapse due to surface tension. Alternatively, a second, larger tube (not shown) may be sealed to the exterior of the sleeve, and used to couple the second set of holes to a second pressure control system, which may be set to a slight vacuum to encourage the collapse of the second set of holes. This method allows for the eradication of interstitial holes without resorting to an intermediate drawing of the preform.

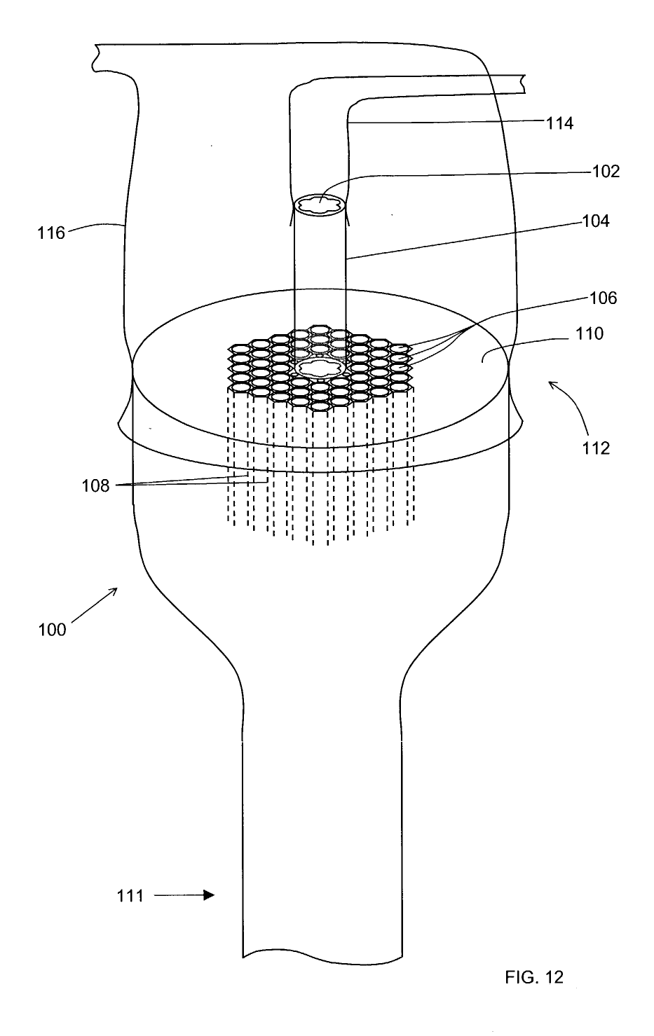

Another embodiment of the invention is shown in FIG. 12. The microstructured optical fiber preform 100 has a core hole 102, formed by core capillary 104, as the first set of holes, while the second set of holes 106, formed by an array of hexagonal sided capillaries 108, forms a photonic crystal structure. The capillaries are sleeved by a larger tube 110. In the embodiment illustrated, the majority of the distal end 111 of the preform has been drawn to reduce its diameter (a process generally known as redraw), so that most of the preform has a diameter on the order of several millimeters. The proximal end 112 of the preform is not redrawn, remaining large enough to ensure facile access to the core capillary 104. In order to compensate for any reduction in the ratio of hole diameter to pitch during the redraw process, the holes of the preform may be etched with flowing aqueous NH₄F.HF or heated gaseous SF₆ in order to increase their diameter. Any interstitial spaces between the hexagonal capillaries forming the second set of holes are removed from the redrawn portion of the preform in the redrawing process. At the proximal end 112 of the preform, a first region, formed by the core capillary, protrudes from the second region, formed by the array of hexagonal sided capillaries, preferably by at least about 6 mm, more preferably by at least about 12 mm, and most preferably by at least about 25 mm. A hollow tube 114 is sealed to the outside of the proximal end of the core capillary 104, enabling the coupling of the first set of holes (the core hole) to a first pressure control system. A second, larger hollow tube 116 may be sealed to the outside of the proximal end of the preform, enabling the coupling of the second set of holes to a second pressure control system.

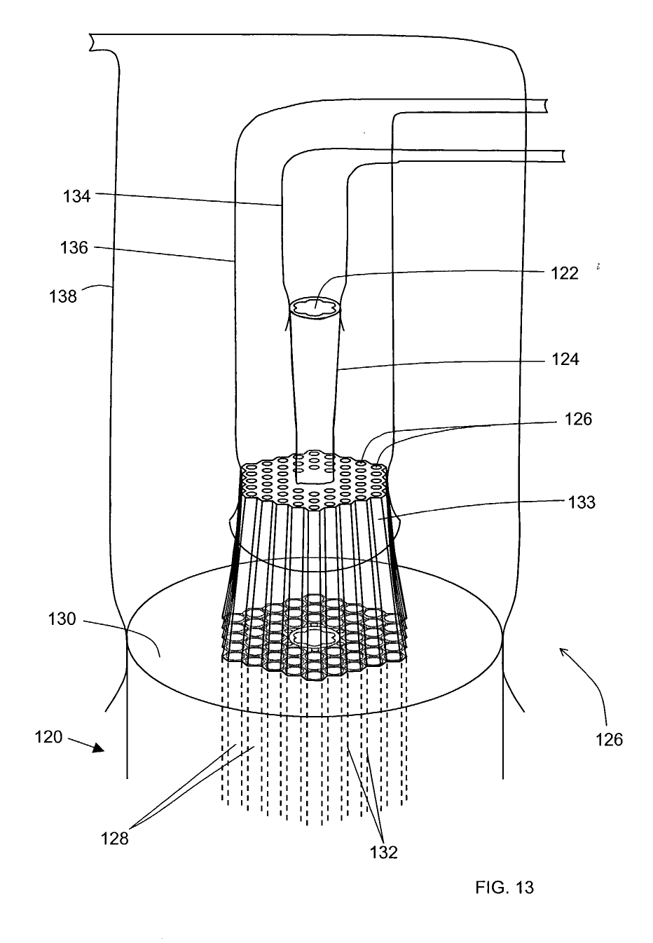

Another embodiment of the present invention is illustrated in FIG. 13. The microstructured optical fiber preform 120 has a core hole 122, formed by core capillary 124, as the first set of holes, while the second set of holes 126, formed by an array of hexagonal-sided capillaries 128, forms a photonic crystal structure. The core capillary 122 may be a single tube having the desired inner cross-sectional geometry, and can be formed, for example, by deposition of glass soot onto a specially-shaped graphite bait rod followed by consolidation of the soot and physical and/or chemical removal of the bait rod. The core capillary 122 may have a round outer cross-sectional shape, as shown, or may have a different shape. For example, the outer cross-sectional shape of the core capillary 122 may have a cross-sectional shape roughly similar to its inner cross-sectional shape. The capillaries 128 are surrounded by a sleeve tube 130. The interstitial spaces between the capillaries 128 form a third set of holes 132. At their proximal ends, the hexagonal-sided capillaries 128 are heated and pulled to fuse the exterior surfaces of the capillaries. The fused portion 133 does not extend into the sleeve. At the proximal end 126 of the preform, the first region (formed by the core capillary) protrudes from the second region (formed by the array of hexagonal-sided capillaries), preferably by at least about 6 mm, at least about 12 mm, or even at least about 25 mm. The second region protrudes from the third region (formed by the sleeve tube), preferably by at least about 6 mm, at least about 12 mm, or even at least about 25 mm. A first hollow tube 134 is sealed to the outside of the proximal end of the core capillary, enabling the coupling of the first set of holes (the core hole) to a first pressure control system. A second, larger hollow tube 136 is sealed to the outside of the proximal end of the exterior of the fused bunch of hexagonal sided capillaries, enabling the coupling of the second set of holes to a second pressure control system. Optionally, a third, even larger hollow tube 138 may be sealed to the sleeve, allowing the coupling of the third set of holes (the interstitial spaces) to a third pressure control system. This method also allows for the eradication of interstitial holes without resorting to an intermediate redraw of the preform, and further allows for individual control of the core hole and the holes forming the photonic crystal cladding.

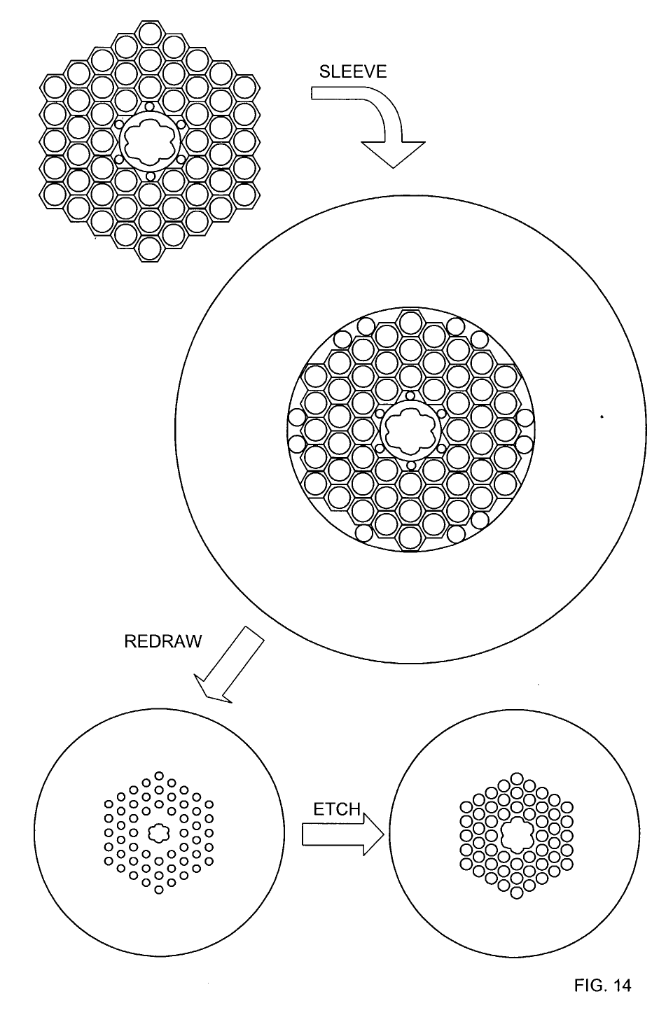

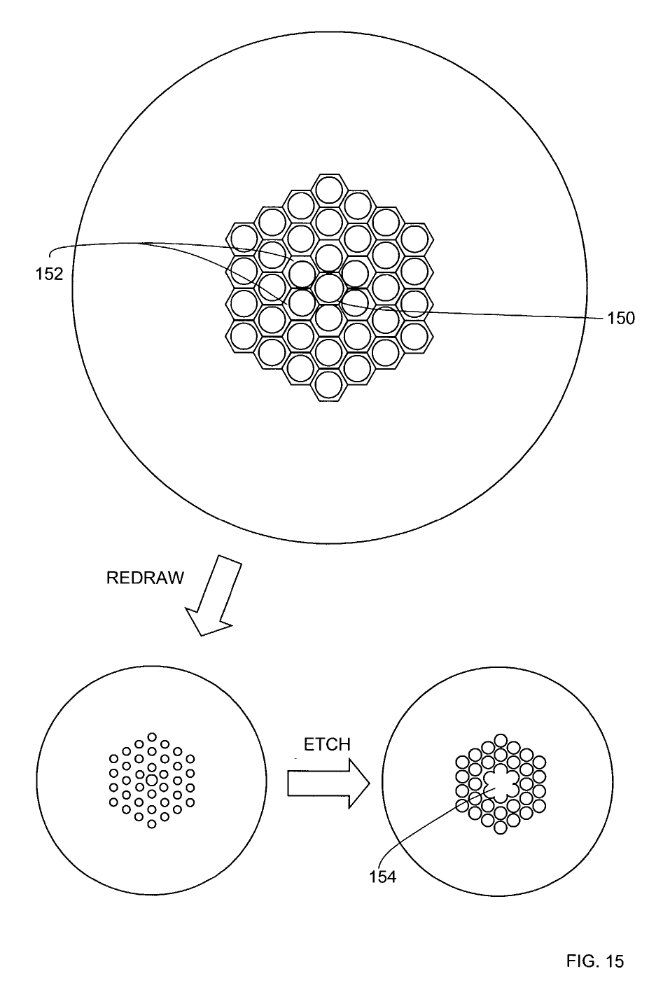

The microstructured optical fiber preforms of the present invention may be made using methods familiar to the skilled artisan. In the commonly used stack-and-draw process, hollow capillaries are bundled together to form the microstructured preform. An example of a stack-and-draw process for the production of a microstructured optical fiber is shown in cross-sectional view in FIG. 14. A group of hollow capillaries is arranged to define the desired microstructure (e.g. a photonic crystal structure having a hollow core defect). The bundle of capillaries may be sleeved by a solid tube. The skilled artisan will assemble the preform using capillaries and tubes having the desired softening point temperatures in order to yield a preform having the desired softening point temperatures. The preform may optionally be redrawn to reduce the preform diameter and etched with aqueous NH₄F.HF or heated gaseous SF₆ to enlarge the size of the holes. Redraw and etching procedures are described, for example, in U.S. patent application Ser. No. 09/563,390, which is incorporated herein by reference.

The core of the microstructured optical fiber may be constructed in a variety of ways. For example, to make a solid-core microstructured optical fiber, the core may be formed by a solid rod arranged among the hollow capillaries. To make a hollow-core microstructured optical fiber, a capillary 150 having a larger inner cross-section may be inserted into the structure. The defect may be enlarged during the etching step by surrounding the central capillary with capillaries having an offset hole 152, as shown in FIG. 15 and described in U.S. patent application Ser. No. 10/085,785, which is incorporated herein by reference. The etching step can be performed to remove the relatively thin walls between the offset capillaries and the central capillary, enlarging the hole 154. The protruding structures may or may not partially or completely recede into the wall of the defect during the draw due to surface tension. Alternatively, a shaped core capillary may be provided as described above with reference to FIG. 13.

It may be desirable to form the preform so that the material of an inner portion of the preform has a higher softening point than the material of an outer portion of the preform, as is described in commonly owned U.S. Provisional Patent Application Serial No. 60/______, (Corning Incorporated docket no. SP02-111, inventors Fajardo, Gallagher, Venkataraman, West), filed on even date herewith and entitled “MICROSTRUCTURED OPTICAL FIBERS AND METHODS AND PREFORMS FOR FABRICATING MICROSTRUCTURED OPTICAL FIBERS”, which is incorporated herein by reference. For example, the difference in softening points may be about 50° C. or greater, about 100° C. or greater, or even about 150° C. or greater. One way to achieve such a difference is to use capillaries formed from silica to form the microstructure, and a fluorine-doped silica tube as the sleeve. In cases where a specially-shaped core capillary is used, it may be desirable to form the core capillary from a material with an even higher softening point (e.g. tantalum-doped silica). Such a difference in softening point allows the inner portion of the preform to be at a somewhat higher viscosity during the draw, leading to less distortion of the inner portion of the microstructure.

As the skilled artisan will appreciate, other methods of constructing preforms for microstructured optical fibers may be used advantageously in the present invention. For example, an extrusion process may be used to form the preform. Other etching and drawing techniques familiar to the skilled artisan may likewise be used in conjunction with the present invention.

Another aspect of the present invention relates to an optical communications system including the microstructured optical fiber of the present invention. The microstructured optical fibers of the present invention may be made with substantially less distortion than conventional microstructured optical fibers, and therefore may have considerably better optical performance than conventional microstructured optical fibers. As such, the microstructured optical fibers of the present invention are especially suited for use in optical communications systems

It will be apparent to those skilled in the art that various modifications and variations can be made to the present invention without departing from the spirit and scope of the invention. For example, in the production of a dual-core photonic band gap fiber having two core capillaries, both core holes may be coupled to a first pressure system. The skilled artisan may practice the present invention using capillaries, holes, and preforms of different sizes and/or geometries. While the invention has been described above with respect to one, two or three pressure systems, the skilled artisan will recognize that more pressure systems may be used in practicing the invention. Thus, it is intended that the present invention cover the modifications and variations of this invention provided they come within the scope of the appended claims and their equivalents.

What is claimed is:

1. A method for making a microstructured optical fiber comprising the steps of
providing a preform having a proximal end and a distal end, and a first set of holes and a second set of holes, both sets of holes being formed longitudinally through the preform between the proximal end and the distal end;
providing at least one pressure system;
coupling the first set of holes to a first of said at least one pressure system at the proximal end of the preform; and
drawing the preform from the distal end to form the microstructured optical fiber. wherein during the drawing step, the second set of holes is substantially uncoupled from the first pressure system.

2. The method of claim 1 wherein said at least one pressure system is a pressure control system individually selected from the group consisting of a positive pressure control system and a negative pressure control system.

3. The method of claim 2, wherein feedback control is used to control the pressure of said at least one pressure control system.

4. The method of claim 1 further comprising the step of coupling the second set of holes to a second of said at least one pressure system at the proximal end of the preform, the second pressure system being substantially uncoupled from the first pressure system.

5. The method of claim 4 wherein, during the drawing step, the pressure of the first pressure system is different than the pressure of the second pressure system.

6. The method of claim 4 wherein the first pressure system or the second pressure system is the atmosphere inside a furnace.

7. The method of claim 4 wherein the first pressure system is a first pressure control system, and the second pressure system is a second pressure control system set to a substantially different pressure than the first pressure control system.

8. The method of claim 4 wherein the first set of holes comprises a core hole, and wherein the second set of holes comprises the holes of a photonic crystal structure.

9. The method of claim 8 wherein the first pressure system is at a lower pressure than the second pressure system.

10. The method of claim 8 wherein the first pressure system is at a higher pressure than the second pressure system.

11. The method of claim 1 wherein the holes of the preform are expanded at its proximal end.

12. The method of claim 11 wherein the step of providing the preform includes the steps of
forming a preform having a proximal end and a distal end, a first set of holes and a second set of holes, each set of holes being formed longitudinally along the preform between the proximal end and the distal end, the preform being formed from a material;
sealing both sets of holes at the proximal end of the preform;
heating the proximal end of the preform to a temperature near the softening point of the material of the preform;
applying pressure to both sets of holes at the distal end of the preform, thereby expanding the holes of the preform at its proximal end; and
cleaving the proximal end of the preform, thereby exposing the expanded holes.

13. The method of claim 1 wherein the step of coupling the first set of holes to a first pressure system includes the steps of
providing a hollow tube having a proximal end and a distal end for each hole of the first set of holes;
inserting the proximal end of one hollow tube into each hole of the first set of holes at the proximal end of the preform;
affixing the proximal end of each hollow tube to the preform using a holding material, thereby coupling the hollow tube to the hole; and
coupling the distal end of each hollow tube to the first pressure system.

14. The method of claim 13 wherein the first set of holes consists of a core hole.

15. The method of claim 13 wherein the holding material is a partially porous material formed using a sol-gel process.

16. The method of claim 15 wherein the sol-gel process uses screening of surface charge to induce gelation.

17. The method of claim 13 wherein the holding material is a substantially non-porous material.

18. The method of claim 1 wherein the preform includes a first region including the first set of holes and a second region surrounding the first region, and wherein at the proximal end of the preform, the first region of the preform protrudes from the second region of the preform.

19. The method of claim 18 wherein the step of providing a preform includes
providing a core rod, a first set of capillaries, each capillary having a hole, and a sleeve tube;
forming a preform by arranging the core rod, the first set of capillaries, and the sleeve so that the core rod is surrounded by the first set of capillaries and the first set of capillaries is surrounded by the sleeve tube, the first set of capillaries and the core rod protruding from the sleeve and forming the first region, the sleeve tube forming the second region.

20. The method of claim 19 further including the step of
heating and pulling the first set of capillaries and the core rod at the proximal end of the preform, thereby fusing the outer surfaces of the capillaries together.

21. The method of claim 20 wherein the step of providing the preform further includes the step of sealing a first hollow tube to the holes of the first set of capillaries.

22. The method of claim 21 wherein the step of providing the preform further includes the step of sealing a second hollow tube to the sleeve tube.

23. The method of claim 1 wherein the preform includes a first region including the first set of holes; a second region including the second set of holes surrounding the first region; and a third region, and wherein at the proximal end of the preform, the first region of the preform protrudes from the second region of the preform, and the second region of the preform protrudes from the third region of the preform.

24. The method of claim 23 wherein the step of providing the preform includes
providing a first set of capillaries and a second set of capillaries, each capillary having a hole, and a sleeve tube; and
forming a preform by arranging the first set of capillaries, the second set of capillaries, and the sleeve tube so that the first set of capillaries is surrounded by the second set of capillaries, and the second set of capillaries is surrounded by the sleeve tube,
wherein the first set of capillaries forms the first region, the second set of capillaries forms the second region, and the sleeve tube forms the third region.

25. The method of claim 24 wherein the first set of capillaries comprises a core capillary, and wherein the step of providing the preform includes
heating and pulling the first set and the second set second set of capillaries at the proximal end of the preform, thereby fusing the outer surfaces of the capillaries together.

26. The method of claim 25 wherein the step of providing the preform further includes the step of sealing a first hollow tube to the first set of capillaries, and sealing a second hollow tube to the second set of capillaries.

27. The method of claim 26 wherein the step of providing the preform further includes the step of sealing a third hollow tube to the sleeve tube.

28. A method for making a microstructured optical fiber comprising the steps of
providing a preform having a proximal end and a distal end, and a first set of holes and a second set of holes, both sets of holes being formed longitudinally through the preform between the proximal end and the distal end;
forming a porous material in each hole of the first set of holes at the proximal end of the preform;
coupling the first set of holes and the second set of holes to a first pressure system; and
drawing the preform from the distal end to form the microstructured optical fiber, wherein the holding material has a porosity sufficient to partially inhibit flow between the
first set of holes and the second set of holes.

29. The method of claim 28 wherein during the drawing step, the second set of holes is at a substantially different pressure than the pressure of the first set of holes.

30. The method of claim 28 wherein the holding material is formed using a sol-gel process.

31. The method of claim 28 wherein the sol-gel process uses screening of surface charge to induce gelation.

32. The method of claim 28 further comprising the steps of
providing a hollow tube having a proximal end and a distal end for each hole of the first set of holes;
inserting the proximal end of one hollow tube into each hole of the first set of holes at the proximal end of the preform; and
coupling the distal end of each hollow tube to a second pressure system, wherein the hollow tubes are affixed to the preform by the porous plug.

33. A microstructured optical fiber preform comprising
a first set of holes and a second set of holes, the holes being formed longitudinally through the preform between a proximal end and a distal end;
wherein the first set of holes is coupled to a first pressure system at the proximal end of the preform, the first pressure system being substantially uncoupled from the second set of holes.

34. The microstructured optical fiber preform of claim 33 wherein the second set of holes is coupled to a second pressure system at the proximal end of the preform.

35. The microstructured optical fiber preform of claim 33 wherein the first set of holes comprises a core hole, and the second set of holes comprises the holes of a photonic crystal structure.

36. The microstructured optical fiber preform of claim 33 wherein the holes of the preform are expanded at its proximal end.

37. The microstructured optical fiber preform of claim 33 further comprising
a hollow tube having a proximal end and a distal end for each hole of the first set of holes, the proximal end of one hollow tube being inserted into the proximal end of each of the holes of the first set of holes of the preform, the proximal end of each hollow tube being affixed to the preform with a holding material, wherein the first set of holes is coupled through the hollow tube to the first pressure system at the proximal end of the preform.

38. The microstructured optical fiber preform of claim 33 wherein the preform includes a first region including the first set of holes and a second region surrounding the first region, and wherein at the proximal end of the preform, the first region of the preform protrudes from the second region of the preform.

39. An optical fiber made by the method comprising the steps of
providing a preform having a proximal end and a distal end, and a first set of holes and a second set of holes, both sets of holes being formed longitudinally through the preform between the proximal end and the distal end;
providing at least one pressure system;
coupling the first set of holes to a first of said at least one pressure system at the proximal end of the preform; and
drawing the preform from the distal end to form the microstructured optical fiber.
wherein during the drawing step, the second set of holes is substantially uncoupled from the first pressure system.

40. An optical communications system including the microstructured optical fiber of claim 39.
